(19) United States
(12) Patent Application Publication
(10) Pub. No.: US 2021/0180565 A1
(43) Pub. Date: Jun. 17, 2021

(54) METHOD FOR OPERATING A WIND TURBINE IN EMERGENCY MODE, AND CONTROLLER AND WIND TURBINE

(71) Applicant: Wobben Properties GmbH, Aurich (DE)

(72) Inventors: Harro HARMS, Wiesmoor (DE); Constantin BERGEMANN, Aurich (DE)

(21) Appl. No.: 16/647,354

(22) PCT Filed: Sep. 7, 2018
(86) PCT No.: PCT/EP2018/074156

§ 371 Date: Mar. 13, 2020

(30) Foreign Application Priority Data
Sep. 20, 2017 (DE) 10 2017 121 750.9

(51) Int. Cl. F03D 7/02

(52) U.S. Cl. CPC F03D 7/0224; F03D 7/0204; F03D 7/0264; F05B 2270/329; F05B 2270/321; F05B 2260/76; F05B 2270/32; F05B 2270/107

(57) ABSTRACT

A method for a wind turbine in an emergency mode. In that case a change in the wind direction and/or a force exerted on the wind turbine is detected and at least one of the rotor blades is adjusted in dependence on the change while maintaining the yaw angle of the yaw setting. A control means for a wind turbine and a wind turbine.

### BACKGROUND

### Technical Field

The invention concerns a method for a wind turbine in an emergency mode as well as a control means and a wind turbine.

### Description of the Related Art

In accordance with the state of the art wind turbines have a plurality of components which can be adjusted in dependence on the prevailing wind factors in order to maximize the energy output of a wind turbine. Energy is required for setting or adjusting the adjustable components.

Accordingly in modern wind turbines for example the rotor blades of an aerodynamic rotor can be rotated about their longitudinal axis, therefore displaced, so that the rotor blades ideally receive the afflux flow of the wind. A lift effect resulting therefrom of the rotor blades serves to generate a torque in a rotor of a generator that is driven by the aerodynamic rotor. Accordingly the kinetic energy of the wind can be converted into electrical energy with the generator of the wind turbine.

In addition modern wind turbines include a wind direction tracking arrangement in order to orient the entire aerodynamic rotor into the prevailing wind direction. The wind direction tracking arrangement is also referred to as yaw adjustment.

Accordingly the rotor blade plane, namely a plane in which the rotor blades of a wind turbine rotate, is always oriented substantially perpendicularly to the wind afflux flow so that this ensures a symmetrical afflux flow to the rotor. Bending moments are reduced and energy output is maximized by the symmetrical afflux flow.

An afflux flow for the rotor accordingly denotes the relationship between the wind direction and the rotor position. In the case of a symmetrical afflux flow the rotor plane is oriented substantially perpendicularly to the wind direction by the wind direction tracking arrangement, or, expressed in other terms, the axis of the rotor in the case of a symmetrical afflux flow is oriented parallel to a directional vector of the current wind. The term parallel afflux flow is therefore also used for the symmetrical afflux flow. Furthermore, with a symmetrical afflux flow the wind meets the rotor plane from the front, that is to say from the side of the rotor, that does not face towards the pod of the wind turbine.

There are situations however in which it is not possible to adapt the components of the wind turbine to the changing wind conditions. Mention may be made here for example of the emergency operation of a wind turbine, in which the wind turbine is separated from the grid and thus cannot take any power from the grid for adjustment of the mechanical components of the wind turbine.

Accordingly the mechanical components of the wind turbine, in particular the rotor shaft with which the rotor is mounted on the stationary part of the wind turbine are designed to be oversized for those situations, to prevent damage due to loadings, for example in the event of a transverse flow to the rotor blades.

Accordingly therefore wind turbines are designed to be more stable than would be necessary for normal operation in which power can be taken from the grid and fed in. Such additional stability however gives rise to additional manufacturing costs and also in normal operation in part reduces the efficiency and thus the output of a wind turbine.

It is therefore known from the state of the art to provide energy storage means in the wind turbine in order to move the rotor blades into a predefined position even in the emergency mode. That can permit spinning of the rotor blades so that at least the speed of rotation of the rotor in the emergency mode when there is no braking device provided for the rotor can be reliably kept below a predetermined speed of rotation upper limit.

An emergency mode which is started as soon as the wind turbine is separated from the grid accordingly provides that the rotor blades are transferred as a one-off operation from the current position into a predefined position. Suitable emergency power sources are designed for that one-off adjustment. Adjustment of the wind direction tracking arrangement or yaw setting, that is to say setting the yaw angle, has hitherto not been provided in the emergency mode because the power required for that, which would also have to be provided in emergency power storage means, would be very high and therefore the provision of an emergency power supply of many times the magnitude of an emergency power supply for adjustment of the rotor blades would be necessary. Accordingly oversizing of the wind turbine is still necessary to avoid damage in an emergency situation with an inclined flow to the blades.

On the German patent applications from which priority is claimed for the present application the German Patent and Trade Mark Office searched the following documents: US 2011/0076142 A1, WO 2007/132303 A1, US 2010/0078939 A1 and US 2011/0280725 A1.

### BRIEF SUMMARY

Stability requirements of wind turbines are to be reduced to preferably avoid oversizing of the wind turbines, which has to be designed for situations involving an inclined afflux flow in an emergency mode or at least to minimise the degree of oversizing.

Provided is a method for a wind turbine in an emergency mode. Accordingly the wind turbine is in an emergency mode and is thus separated from the power grid. Separation from the grid does not necessarily mean here that a physical separation has to be implemented, but it also includes that situation. At any event separation from the grid means that no power for operation of the wind turbine can be taken from the grid. The term grid is used to mean a power supply grid, by way of which the wind turbine in normal operation provides the generated energy to feed that for example to consumers.

A change in a wind direction is detected. In addition or alternatively a change in at least one force acting on the wind turbine is detected. Thereupon, while maintaining the current yaw angle of the yaw setting, at least one of the rotor blades is adjusted to a different angle, that angle being dependent on the detected change.

Detection here is not intended to be interpreted as measurement. Rather, preferably for detecting a change in wind direction, firstly the wind direction is measured and/or for detecting a change in force firstly the force is measured, continuously or in interval relationship, preferably absolutely. It is only then that a change is detected from that measurement, taking account of previous measurements, for example in a control means, if the measurement values for the currently measured wind direction and/or force differ from a previously measured wind direction or force.

A change in the wind direction means that firstly there is a first wind direction and that changes to a second wind direction. That change from the first wind direction to the second wind direction then corresponds to a detectable change in the wind direction. A change in a force acting on the wind turbine concerns a change in a force which is preferably exerted by the current or a prevailing wind. If the wind changes, that is to say in particular the wind strength or the wind direction, then certain forces which act on the wind turbine, in particular the components thereof, change. At least one of those changes in force which is preferably predefined therefore changes in dependence on the wind, with that change being detected.

That purpose is served for example by one or more sensors like strain gauges which are arranged for example on the turbine tower and/or at the rotor blades. Preferably three or four sensors are arranged on the tower uniformly in the peripheral direction for that purpose. The term force is also used here generally to denote any force parameter which, besides directing acting forces, also embraces moments, in particular flexural moments, or other loads.

According to the method therefore the wind direction or at least one force is monitored, measured or detected, and in the situation where the wind direction or force changes, that change is detected so that the further steps in the method are then carried out. Accordingly at least one of the rotor blades is set differently from the position which was adopted before the change in wind direction or the change in force. If therefore the rotor blade has a first position with the first wind direction or force then the rotor blade is adjusted in such a way that it is in a second position after the change, that is to say with the second wind direction or force.

That makes it possible that, in the situation where an inclined afflux flow to the wind turbine occurs and adjustment of the yaw angle is not possible by virtue of the emergency mode then nonetheless the force acting on the wind turbine by the wind can be minimized. Loading on the wind turbine is thus reduced with the inclined afflux flow and the wind turbine therefore does not have to be oversized or can be at least to a lesser degree oversized.

According to a first embodiment the at least one rotor blade is adjusted to an angle which differs from an angle for a feathered position, in particular in the case of a symmetrical afflux flow, with the retained yaw angle, namely the current yaw angle.

According to a further embodiment adjustment of at least one of the rotor blades is effected after a change in the wind direction and/or a change in the force was detected such that an angle of the rotor blade is set to the angle from which there result the forces and/or the flexural moments on the at least one rotor blade and/or the rotor and/or the rotor shaft, which are minimized in comparison with one or more other angles. Preferably the rotor blade is moved into a feathered position relative to the fresh wind direction, that is to say the wind direction after the change, so that forces occurring by virtue of that wind direction substantially cancel each other out on the suction and pressure sides.

Accordingly the forces resulting on the wind turbine are reduced when there is an inclined afflux flow.

According to a further embodiment a change in the wind direction is detected when a horizontal differential angle between a first wind direction and a second wind direction is above a predefined differential angle threshold value. Accordingly no change in the wind direction is detected and the rotor blades remain in the current position as long as the differential angle is at or below the differential angle threshold value. That avoids blade adjustment already being effected at low differential angles, although there are still no high loads exerted on the rotor blade or the wind turbine, due to the inclined afflux flow which is thus only slight. Unnecessary reciprocating adjustment of the rotor blades is thus avoided. The differential angle threshold value is preferably in a range of 1 to 10 degrees, particularly in a range of 2 to 5 degrees, and can be predetermined by simulation.

Additionally or alternatively in this embodiment a change in the force exerted on the wind turbine is detected if a differential force between a first detected force and a second detected force is above a first predefined differential force threshold value. Equally no change in the force exerted on the wind turbine is detected if the differential force is at or below the differential force threshold value.

According to a further embodiment a wind speed is determined and compared to a predefined wind speed threshold value. If the wind speed is above the predefined wind speed threshold value then in the situation where a change in the wind direction or the force on the wind turbine is detected, the yaw angle is maintained and at the same time the at least one rotor blade is adjusted to another angle. If the wind speed is below or at the wind speed threshold value the rotor blades remain in the current position. That procedure of determining the wind speed and comparing it to the wind speed threshold value is preferably effected prior to the step of detecting a change in the wind direction. The wind speed threshold value can also be predetermined by simulation.

Account is taken of the fact here that damage to the wind turbine can only occur as from the occurrence of given forces caused by high wind speeds. If wind speeds remain below that limit, which is referred to here as the wind speed threshold value, there is no danger to the wind turbine and there is therefore also no need for adjustment. As previously, in this embodiment therefore it is possible to avoid unnecessary adjustment procedures for the rotor blade or blades.

According to a further embodiment a change in the at least one force acting on at least one component of the wind turbine, in particular on one or more rotor blades, the rotor or the rotor shaft, is detected when a monitored force exceeds a predefined force threshold value. For example a sensor like for example a strain gauge serves to monitor the force. In that way for example bending forces on the rotor shaft or one or more rotor blades are measured and a force which is acting on at least one component of the wind turbine is determined from the measurement. That force or those forces are then compared to a force threshold value.

Detection of a change and retention of the yaw angle of the yaw setting and adjustment of at least one of the rotor blades is effected only when the given force is above a force threshold value. If the force is below the force threshold value or at that value then the rotor blades remain in the current position. That operation of determining the at least one force and comparing it to the force threshold value is preferably effected prior to the step of detecting a change in the wind direction. The force threshold value can also be predetermined by simulation.

Alternatively or additionally to the wind speed therefore it is possible to determine a force exerted on the wind turbine by the wind and by establishing the force threshold value at least one of the rotor blades is then adjusted only as soon as that force could lead to damage to the wind turbine. If on the other hand accordingly there is no risk of damage due to the given force which occurs it is possible to avoid adjustment of the rotor blades.

According to a further embodiment the power for adjustment of the rotor blades is taken from an emergency power supply, in particular an accumulator, of the wind turbine.

The method is therefore carried out in the emergency mode when therefore no energy can be taken from the grid to which the wind turbine is connected. Accordingly adjustment of the rotor blades can be effected without having to take power from the grid by the provision of the emergency power supply and supplying the motors for adjustment of the rotor blades.

According to a further embodiment the emergency power supply in the emergency mode is designed or sized for two or more adjustment operations of all rotor blades, in particular when it is assumed that each adjustment operation includes a rotation of each rotor blade about its longitudinal axis through at least 90 degrees. Multiple adjustment of the rotor blades with an inclined afflux flow which change a plurality of times during the emergency mode of operation is thus possible. Accordingly, after for example a first change in a wind direction has been detected and the rotor blades have been correspondingly adjusted, the rotor blades can be freshly set upon a further change in the wind direction.

According to a further embodiment the rotor blades are rotatable through 360 degrees about the longitudinal axis. If accordingly the wind direction changes through 180 degrees in relation to a symmetrical afflux flow from the front side of the rotor then the directional rotor of the wind after the change in wind direction accordingly points to the rear side of the rotor blade plane. In that case the rotor blades can be adjusted through 180 degrees. In the case of transverse afflux flows the rotor blades can be respectively adjusted accordingly through 90 degrees or 270 degrees in relation to a feathered position when there is a parallel afflux flow, that is to say with a symmetrical afflux flow, as viewed at the current yaw angle. Irrespective of the wind direction the rotor blades can thus be so adjusted that a force which is as low as possible acts on the rotor blades due to the wind independently of the yaw angle.

According to a further embodiment the rotor blades are individually adjustable. Accordingly each rotor blade can be set in such a way that a force which is as low as possible due to the wind acts on the respective rotor blade.

Provided is control means for a wind turbine, adapted to carry out the method according to one of the above-mentioned embodiments. Preferably for that purpose the control means includes a computer unit and one or more sensors, in particular for detection of the wind direction, the wind speed, at least one force acting on a component of the wind turbine, and/or further parameters as sensor data. The wind turbine is then adapted to transmit the sensor data to the control means.

Furthermore the control means serves to operate the wind turbine in an emergency mode with an emergency power supply for adjustment of the rotor blades. In that situation the control means is adapted to cause actuators for adjustment of the rotor blades to be adjusted in accordance with a position which is determined in the control means. Adjustment is determined in dependence on a detected change in the wind direction.

The invention further concerns a wind turbine having a control means according to one of the above-described embodiments.

### BRIEF DESCRIPTION OF THE SEVERAL VIEWS OF THE DRAWINGS

Further configurations will be apparent from the embodiments by way of example described in greater detail with reference to the figures.

FIG. 1 shows a side view of a wind turbine,

FIG. 2 shows a plan view of a wind turbine with rotor blades in the feathered position,

FIG. 3 shows the view of FIG. 2 with changed rotor blade position,

FIG. 4 shows the plan view from FIGS. 2 and 3 with the rotor blade position again changed, and

FIG. 5 shows the steps of an embodiment of the method.

### DETAILED DESCRIPTION

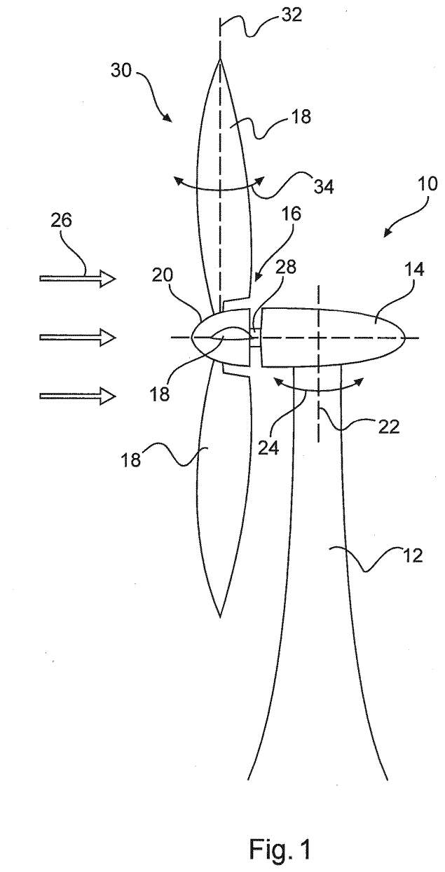

FIG. 1 shows a wind turbine 10 having a tower 12 and a pod 14. Arranged on the pod 14 is an aerodynamic rotor 16 having three rotor blades 18 and a spinner 20. In operation the rotor 16 is driven in rotation by the wind and thereby drives a generator in the pod 14.

The pod 14 is adjustable about a perpendicular axis 22 in the direction of the arrow 24. That adjustment is also referred to as the yaw adjustment or wind direction tracking and thus serves for setting the yaw angle of the wind turbine 10. The yaw setting accordingly serves to orient the rotor 16 to the prevailing wind direction 26. The yaw or yaw angle shown here is defined for example as the yaw angle of zero degrees. With the illustrated yaw angle and the prevailing wind direction 26 reference is made to a parallel afflux flow or a symmetrical afflux flow. That is the case when the wind 26 impinges on the rotor 16 substantially parallel to a rotor shaft 28 from the front side 30.

The rotor blades 18 can also be rotated about their longitudinal axis 32. That is illustrated by the arrow 34. In the present case the rotor blades 18 are oriented in a feathered position. This means that the wind which is incident on the rotor 16 from the wind direction 26 produces no or only a slight torque on the rotor shaft 28. The reason for this is that the position of the rotor blades 18 provides that the forces acting on the respective rotor blade 18 substantially cancel each other out or add up to make zero.

That feathered position is preferably assumed when the wind turbine 10 is not to feed any energy into the grid or the wind turbine 10 is in an emergency mode of operation in which no power for further controlled adjustment of the wind turbine 10 can be taken from the grid.

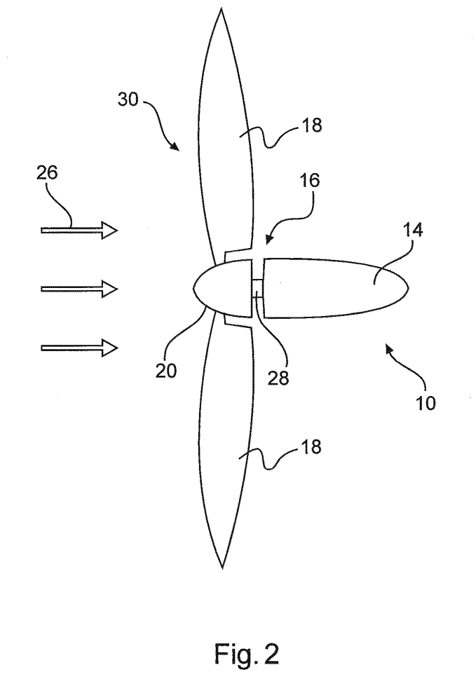

FIG. 2 shows a plan view of the wind turbine 10 of FIG. 1. The identical references denote the same features. In FIG. 2 the wind turbine 10 is also oriented in relation to the wind and this therefore involves a parallel afflux flow. The rotor blades 18 are also set in the feathered position. The loading on the wind turbine 10 is thus minimal.

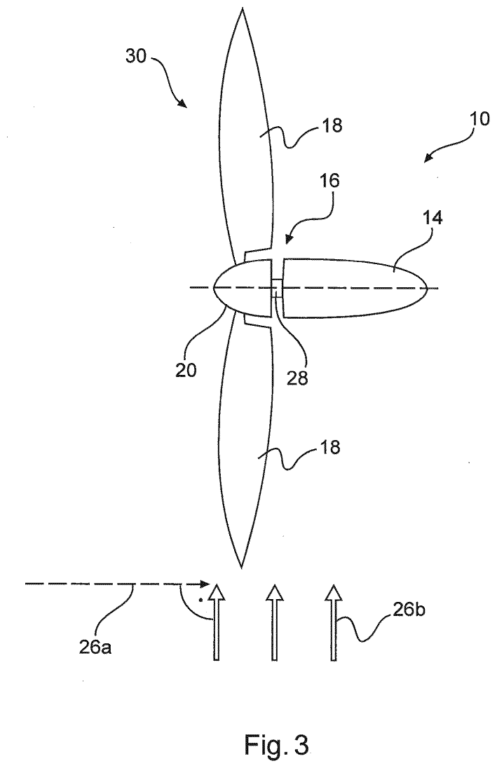

FIG. 3 now shows a first example for adjusted rotor blades 18 in accordance with the method. In this case the wind direction 26 has now turned through 90 degrees from the first wind direction 26a as shown in FIG. 2 into a second wind direction 26b in the clockwise direction in relation to the wind direction in FIG. 2. Accordingly this now no longer involves a parallel afflux flow as shown in FIG. 2 but an inclined afflux flow generally or here specifically a transverse afflux flow. Accordingly the wind turbine 10 detects that there has been a change in the wind direction from the first wind direction 26a into the second wind direction 26b. Alternatively or additionally that change in wind direction can also be detected by a change in a force acting on the wind turbine 10. Loads or changes in load are for that purpose monitored for example with strain gauges.

As shown in FIG. 3 the yaw angle of the yaw setting is maintained in spite of the change in the wind direction and the rotor blades 18 are moved to a different angle which can also be referred to as the second angle. The second angle differs from an angle for a feathered position in relation to a parallel afflux flow with the current yaw orientation. More specifically accordingly the rotor blades 18 are now set in relation to the wind in such a way that as low a force as possible acts on the rotor blade 18 due to the wind. It can be seen from FIG. 3 that the rotor blades 18 are adjusted through 90 degrees in relation to the position in FIG. 2.

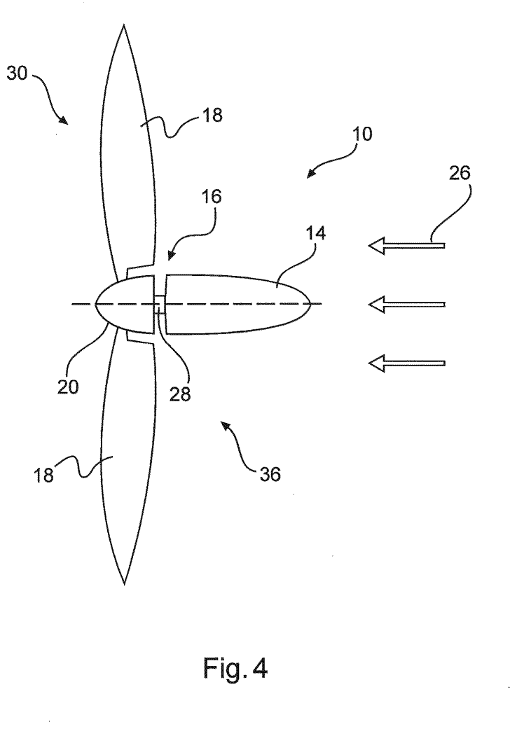

A further example for a detected changed wind direction 26 and/or changed force on the wind turbine 10 is shown in FIG. 4 in which the wind direction 26 is now directed on to the rear side of the wind turbine 10. Here too the rotor blades 18 are adjusted with the yaw angle being maintained as a change in the wind direction or force, namely a wind direction, was detected, which is different from the parallel afflux flow with the current yaw orientation. The rotor blades 18 are here adjusted in such a way that as viewed from the wind direction 26 they are in a feathered position, wherein that feathered position differs from the feathered position with the parallel afflux flow with the current yaw orientation, as in FIG. 2.

Accordingly the position of the rotor blades 18, namely the pitch angle, is adapted to the changing wind directions 26, in dependence on the wind direction 26.

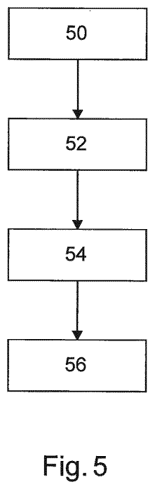

FIG. 5 shows an embodiment of the steps in the method according to an embodiment. In step 50 the wind direction 26 or a force on the wind turbine 10 is monitored while step 52 detects that the wind direction 26 or the force has changed. In step 54 therefore the yaw angle of the yaw setting of the wind turbine is maintained and in step 56 the rotor blades 18 are adjusted in dependence on the changed wind direction 26.

1. A method comprising:
operating a wind turbine in an emergency mode, the wind turbine comprising a plurality of rotor blades, the operating comprising:
a) detecting at least one of: a change in a wind direction or a change in at least one force exerted on the wind turbine,
b) maintaining a yaw angle of a yaw setting, and
c) adjusting at least one rotor blade of the plurality of rotor blades in dependence on the detected change.

2. The method according to claim 1 wherein in step c) the at least one rotor blade is adjusted to an angle which differs from an angle for a feathered position of the respective rotor blade with the yaw angle.

3. The method according to claim 1 wherein the at least one rotor blade in step c) is set to an angle at which a force on the wind turbine is minimized in comparison with a plurality of or all other angles.

4. The method according to claim 1 wherein the change in the wind direction is detected when a horizontal differential value between a first wind direction and a second wind direction is above a predefined differential angle threshold value and no change in the wind direction is detected when the differential angle is at or below the differential angle threshold value.

5. The method according to claim 1 further comprising determining a wind speed, and wherein step c) is carried out when the wind speed is above a predefined wind speed threshold value.

6. The method according to claim 1 wherein the detecting is step a) comprises detecting the change in the at least one force when a monitored force exceeds a predefined force threshold value.

7. The method according to claim 1 wherein the adjusting comprises using an emergency power supply for power for adjustment the at least one of the plurality of rotor blades.

8. The method according to claim 7 wherein the emergency power supply in an emergency mode is designed for two or more adjustment operations for all of the plurality of rotor blades.

9. The method according to claim 1 wherein the plurality of rotor blades are rotatable through 360 degrees about the longitudinal axis of the respective rotor blade.

10. The method according to claim 1 wherein each of the plurality of rotor blades are individually adjusted.

11. A control means for a wind turbine wherein the control means is adapted to carry out the method according to claim 1.

12. The control means according to claim 11 wherein the control means includes one or more sensors for detecting at least one of: a change in a wind direction and/or or a change in a force exerted on the wind turbine.

13. A wind turbine comprising the control means according to claim 11.

14. The method according to claim 3 wherein the force includes a plurality of forces exerted on the at least one rotor, the rotor, or the rotor shaft.

15. The method according to claim 3 wherein the force includes bending moments exerted on the at least one rotor blade, the rotor, or the rotor shaft.

16. The method according to claim 1 wherein the change in the at least one force exerted on the wind turbine is detected when a differential force between a first force and a second force is above a first predefined differential force threshold value and no change in the at least one force exerted on the wind turbine is detected when the differential force is at or below the differential force threshold value.

17. The method according to claim 7 wherein the emergency power supply is an accumulator.

18. The method according to claim 8 wherein each adjustment operation includes a rotation of each rotor blade about its longitudinal axis through at least 90 degrees.
